(19) United States
(12) Patent Application Publication
(10) Pub. No.: US 2026/0320919 A1
(43) Pub. Date: Oct. 15, 2026

(54) METHOD AND APPARATUS FOR UPDATING POINT CLOUD MAP, ENGINEERING VEHICLES, AND STORAGE MEDIA

(71) Applicants: JIANGSU XCMG CONSTRUCTION MACHINERY RESEARCH INSTITUTE LTD., Xuzhou, Jiangsu (CN); JIANGSU XCMG STATE KEY LABORATORY TECHNOLOGY CO., LTD., Xuzhou, Jiangsu (CN)

(72) Inventors: Houxue MA, XUZHOU (CN); Jian LIU, XUZHOU (CN); Hongjun PU, XUZHOU (CN)

(21) Appl. No.: 18/998,050

(22) PCT Filed: Feb. 6, 2024
(86) PCT No.: PCT/CN2024/076408

§ 371 Date: Jan. 23, 2025

(30) Foreign Application Priority Data
Dec. 13, 2023 (CN) 202311718181.7

(51) Int. Cl. G06T 19/00; G01S 17/89; G06T 17/05

(52) U.S. Cl. CPC G06T 19/00; G01S 17/89; G06T 17/05

(57) ABSTRACT

The present disclosure provides a method and an apparatus for updating a point cloud map, an engineering vehicle, and a storage medium. The method for updating the point cloud map includes the following steps: loading an initial global point cloud map corresponding to a current position of an engineering vehicle; dividing the global point cloud map into areas to obtain a plurality of local point cloud maps; determining an area where each vehicular lidar of a plurality of vehicular lidars is currently located; updating local point cloud maps corresponding to excavation and loading areas at a first predetermined period, and updating local point cloud maps corresponding to non-excavation and loading areas at a second predetermined period by the plurality of the vehicular lidars; and updating the global point cloud map according to updating results of the plurality of the local point cloud maps.

### CROSS-REFERENCE TO RELATED APPLICATIONS

The present disclosure is based on and claims priority of Chinese application for invention No. 202311718181.7, filed on Dec. 13, 2023, the disclosure of hereby incorporated herein by reference in its entirety.

### TECHNICAL FIELD

The present disclosure relates to the technical field of engineering machinery control, and in particular, to a method and an apparatus for updating a point cloud map, an engineering vehicle, and a storage medium.

### BACKGROUND

As an important part of intelligent and unmanned operations, a point cloud map is mainly used to construct a three-dimensional model of a real scene for unmanned excavators to plan excavation and loading tasks.

A perception system of an unmanned excavator consists of multiple lidars. During excavation and loading operations, the excavator usually rotates on a relatively fixed platform to perform the excavation and loading operations and sometimes changes its working position within a small range. For this typical working condition, the perception system needs to establish a three-dimensional point cloud map of the surrounding environment in real time, and the following requirements should be met: (1) in a case where the excavator returns to the platform after refueling or servicing, or when the work area of the excavator is changed, a point cloud map created previously must be automatically loaded; (2) in a case where the bucket performs the excavation operation in an excavation area or the loading operation on a truck, the geometric shape of the material in the excavation and loading area changes, so the perception system must be able to dynamically update the point cloud map of the excavation and loading areas in real time; (3) in a case where a non-excavation and loading area is affected by a landslide of materials on the side wall or other equipment entering the site for crushing and cleaning operations, the situation of the working place changes and the perception system must be able to update the map; (4) in a case the multiple lidars are enabled, the perception system must be able to update the real-time maps for the multiple lidars simultaneously; (5) in a case where the excavator continuously rotates to perform repeated excavation and loading operations, the lidars of the perception system continue to map the 3D environment, resulting in continuous accumulation of the point clouds, so it is necessary to reasonably limit the size of the point cloud map and ensure the uniformity of the map.

### SUMMARY

In the first aspect of this disclosure, method for updating a point cloud map is provided, comprising: loading an initial global point cloud map corresponding to a current position of an engineering vehicle; dividing the global point cloud map into areas to obtain a plurality of local point cloud maps; determining an area where each vehicular lidar of a plurality of vehicular lidars is currently located; updating local point cloud maps corresponding to excavation and loading areas at a first predetermined period, and updating local point cloud maps corresponding to non-excavation and loading areas at a second predetermined period by the plurality of the vehicular lidars; and updating the global point cloud map according to updating results of the plurality of the local point cloud maps.

In some embodiments, the updating the local point cloud maps corresponding to the excavation and loading areas at the first predetermined period comprises: generating the local point cloud maps corresponding to the excavation and loading areas at the first predetermined period; determining an area where a bucket of the engineering vehicle is located; cleaning a local point cloud map of the area where the bucket is located in a case where the engineering vehicle is carrying out an excavation and loading operation; and regenerating the local point cloud map corresponding to the area where the bucket is located.

In some embodiments, the determining the area where the bucket of the engineering vehicle is located comprises: determining the area where the bucket is located according to a current position P_{w_bucket} of the bucket.

In some embodiments, the current position P_{w_bucket} of the bucket is determined according to a current pose R_{w_b} and a current position P_{w_b} of an excavator carrier of the engineering vehicle, and a position P_{b_bucket} of the bucket in an excavator carrier coordinate system.

In some embodiments, the current position P_{w_bucket} of the bucket is a sum of the current position P_{w_b} of the excavator carrier and a product of the current pose R_{w_b} of the excavator carrier and the position P_{b_bucket} of the bucket in the excavator carrier coordinate system.

In some embodiments, the determining the area where the bucket of the engineering vehicle is located comprises: dividing the local point cloud maps into spatial grids; and determining the area where the bucket is located according to a grid where the bucket is currently located.

In some embodiments, the updating local point cloud maps corresponding to the non-excavation and loading areas at the second predetermined period comprises: updating the local point cloud maps corresponding to the non-excavation and loading areas in background at the second predetermined period; extracting keyframe features of the local point cloud maps corresponding to the non-excavation and loading areas, and extracting real-time point cloud features; detecting feature changes according to the keyframe features and the real-time point cloud features; and updating point cloud maps corresponding to areas with an amount of the feature changes greater than a predetermined threshold.

In some embodiments, the extracting the keyframe features of the local point cloud maps corresponding to the non-excavation and loading areas comprises: dividing the local point cloud maps corresponding to the non-excavation and loading areas into a plurality of cells with a predetermined size; decomposing features of each cell of the plurality of the cells to determine whether a feature type of the each cell is a plane feature type; decomposing a feature covariance of a plurality of cells with the plane feature type to obtain a rotation matrix; transforming directions of the features of the each cell according to the rotation matrix to obtain a rotationally invariant feature direction; extracting keyframes of the each cell according to the feature direction; and establishing a feature histogram of an extracted keyframes.

In some embodiments, the decomposing features of the each cell of the plurality of the cells to determine whether the feature type of the each cell is the plane feature type comprises: decomposing features of the each cell to obtain a first cell feature value λ₁, a second cell feature value λ₂, and a third cell feature value λ₃, wherein λ≥λ₂λ₃; and determining the each cell has a plane feature type in a case where the second cell feature value λ₂ is much greater than the third cell feature value λ₃.

In some embodiments, the decomposing the feature covariance of the plurality of the cells with the plane feature type to obtain the rotation matrix comprises: decomposing the feature covariance to obtain a feature vector V_{d}; and obtaining the rotation matrix R according to the feature vector V_{d}.

In some embodiments, the feature vector V_{d}=[V_{d1} V_{d2} V_{d3}]; and the rotation matrix R=[V_{d1} V_{d2} V_{d1}×V_{d2}].

In some embodiments, a center of the initial global point cloud map is a current position P_{w_b} of the excavator carrier of the engineering vehicle, and a radius of the initial global point cloud map is a working radius of the engineering vehicle.

In some embodiments, the current position P_{w_b} of the excavator carrier is determined according to a position P_{w_g} and a pose R_{w_g} of an positioning sensor of the excavator in the global coordinate system, and a position P_{g_b} of the excavator carrier coordinate system relative to a positioning antenna.

In some embodiments, the current position P_{w_b} of the excavator carrier is a sum of the position P_{w_g} of the excavator positioning sensor in the global coordinate system and the product of the pose R_{w_g} of the excavator positioning sensor in the global coordinate system and the position P_{g_b} of the excavator carrier coordinate system relative to the positioning antenna.

In the second aspect of this disclosure, an apparatus for updating the point cloud map is provided, comprising: a first processing module configured to load an initial global point cloud map corresponding to a current position of an engineering vehicle; a second processing module configured to divide the global point cloud map into areas to obtain a plurality of local point cloud maps; a third processing module configured to determine an area where each vehicular lidar of a plurality of vehicular lidars is currently located; a fourth processing module configured to update local point cloud maps corresponding to excavation and loading areas at a first predetermined period, and update local point cloud maps corresponding to non-excavation and loading areas at a second predetermined period by the plurality of the vehicular lidars; and a fifth processing module configured to update the global point cloud map according to updating results of the plurality of the local point cloud maps.

In the third aspect of this disclosure, an apparatus for updating a point cloud map is provided, comprising: a processor; and a memory coupled to the processor, storing program instructions which, when executed by the processor, cause the processor to implement the method according to any one of the above embodiments.

In a fourth aspect of the present disclosure, there is provided an engineering vehicle, comprising a point cloud map updating apparatus as described in any of the above embodiments.

In some embodiments, the engineering machine comprises an excavator.

According to a fifth aspect of embodiments of the present disclosure, there is provided a computer-readable storage medium stored thereon computer instructions that, when executed by a processor, implement the method according to any one of the above embodiments.

According to a sixth aspect of embodiments of the present disclosure, there is provided a computer program comprising computer instructions that, when executed by a processor, implement the method according to any one of the above embodiments.

Other features and advantages of the present invention will become apparent from the following detailed description of exemplary embodiments of the present disclosure with reference to the accompanying drawings.

### BRIEF DESCRIPTION OF THE DRAWINGS

In order to more clearly explain the embodiments of the present invention or the technical solutions in the prior art, a brief introduction will be given below for the drawings required to be used in the description of the embodiments or the prior art. It is obvious that, the drawings illustrated as follows are merely some embodiments of the present disclosure. For a person skilled in the art, he or she may also acquire other drawings according to such drawings on the premise that no inventive effort is involved.

FIG. 1 is a schematic diagram showing an excavation and loading scene according to one embodiment of the present disclosure;

FIG. 2 is a flowchart of a method for updating the point cloud map according to one embodiment of the present disclosure;

FIG. 3 is a flowchart of a method for updating the point cloud map according to another embodiment of the present disclosure;

FIG. 4 is a flowchart of a method for updating the point cloud map according to still another embodiment of the present disclosure;

FIG. 5 is a schematic structure diagram of an apparatus for updating the point cloud map according to one embodiment of the present disclosure;

FIG. 6 is a schematic structure diagram of an apparatus for updating the point cloud map according to another embodiment of the present disclosure;

FIG. 7 is a schematic structure diagram of an engineering vehicle according to an embodiment of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by persons of ordinary skill in the art based on the embodiments of the present disclosure without creative efforts shall fall within the protection scope of the present disclosure.

Unless otherwise specified, the relative arrangement, numerical expressions and values of the components and steps set forth in these examples do not limit the scope of the invention.

At the same time, it should be understood that, for ease of description, the dimensions of the various parts shown in the drawings are not drawn to actual proportions.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

The inventors found that the point cloud map updating schemes in related technologies cannot update the point cloud map for excavation and loading areas in a case where the scene changes in a timely manner, which cannot meet the requirements of excavation and loading scene.

In view of this, the present disclosure provides a point cloud map updating scheme that can timely update the point cloud map for excavation and loading areas with scene changes, thereby effectively meeting the requirements of excavation and loading scenarios.

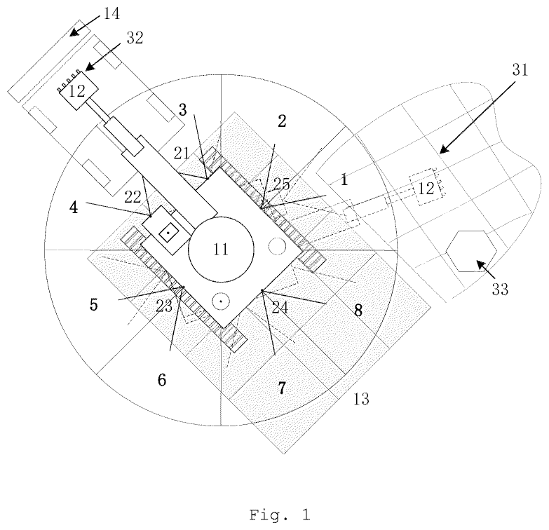

FIG. 1 is a schematic diagram showing an excavation and loading scenario according to one embodiment of the present disclosure. As shown in FIG. 1, an excavator 11 is composed of a walking device, a rotation device, a boom device, and a bucket. During an excavation and loading operation, the excavator 11 is parked on the loading platform 13 near a material 33. The bucket 12 is rotated to an excavation area 31 by the rotation device, and is controlled to excavate by the boom device. After the excavation is completed, the boom is lifted and the excavated material is rotated to a loading area 32 by the rotation device. The excavated material is then loaded into the compartment of a truck 14. The above excavation and loading operation is repeated until the truck is full.

Several lidar sensors 21-25 are mounted on the excavator for point cloud mapping of the material area and the loading area. The excavator is also equipped with a GPS (Global Positioning System)/IMU (Inertial Measurement Unit) for global positioning of the excavator. The excavator loads an initial point cloud map and updates the global point cloud map according to the global position.

A point cloud map of the material area is used to represent the distribution of the material to be excavated, and provide information such as where the material is located and the shape and size of the material, to facilitate the excavator's excavation planning. When a change in the shape of the material is detected after an excavation, a point cloud map updating system should be able to update the point cloud map of the material area in time for the next excavation planning.

The point cloud map updating system should be able to update the shape of the material area in background as changes occur in the material area due to non-excavation actions, such as sliding of the material, falling rocks in the truck parking area, and falling rocks in the excavator driving area (if sliding or falling occurs in the current excavation or loading area, the map will be updated in real time).

The point cloud map of the loading area is used to represent the distribution of material on the truck, and provide information such as where to load and the shape and size of the loaded material for the excavator's load planning. When a change in the shape of the material on the truck is detected after a loading operation, the point cloud map updating system should be able to update the point cloud map of the loading area in time for the next load planning.

The field of view of a single lidar is limited, for example, the field of view of a single lidar shown in FIG. 1 is 77 degrees. During excavation and loading operations, the excavator typically rotates within a small range to improve loading efficiency. Therefore, multiple lidar s can be mounted on the vehicle body to compensate for blind spots. As an example, FIG. 1 shows 5 lidars 21-25 disposed on the left and right in front of the excavator, and on the left, right and rear of the excavator, respectively.

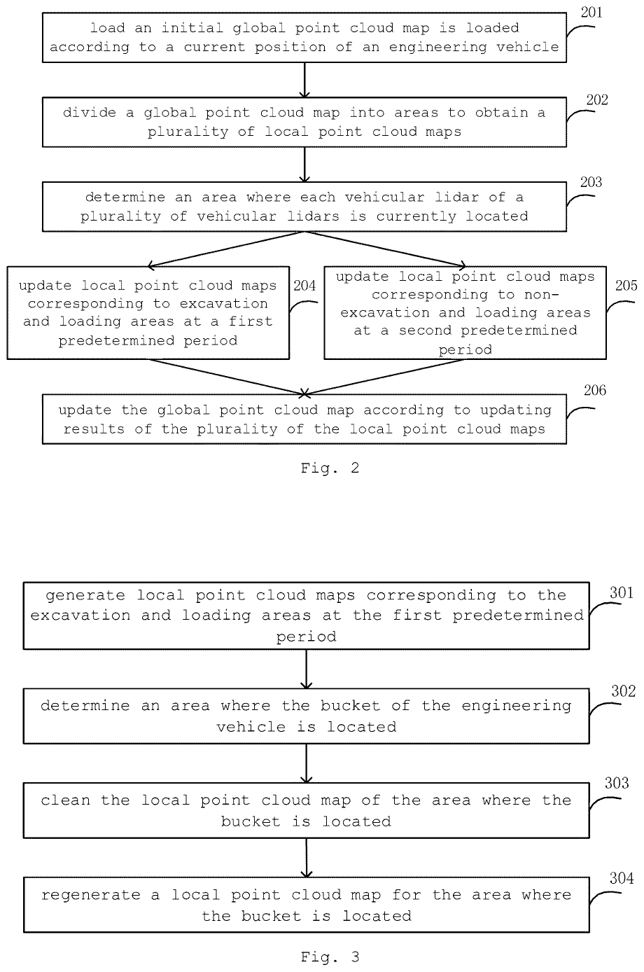

FIG. 2 is a flowchart of a point cloud map updating method according to one embodiment of the present disclosure. In some embodiments, the following point cloud map updating method is performed by a point cloud map updating apparatus.

In step 201, an initial global point cloud map is loaded according to a current position of an engineering vehicle.

It should be noted that when the excavator is refueled or serviced and goes back to the platform, or when the excavator's working area is changed, a position and pose T_{w_g} of the excavator's GPS/IMU positioning sensor in a global coordinate system can be obtained via the GPS. The current position of the excavator carrier P_{w_b} can be obtained according to the following formula (1). The position and pose of the each lidar in the global coordinate system T_{w_l} (R_{w_l},P_{w_l}) can be obtained according to the following formula (2), and the position of the bucket in the global coordinate system P_{w_bucket} can be obtained according to the following formula (3).

$${P}_{w \_ b} = {R}_{w \_ g} * {P}_{{g \_}_{b}} + {P}_{{w \_}_{g}} \qquad ( 1 )$$

$${T}_{w \_ l} = {T}_{w \_ g} * {T}_{g \_ b} * {T}_{b \_ i} * {T}_{i \_ l} \qquad ( 2 )$$

$${P}_{w \_ bucket} = {R}_{w \_ b} * {P}_{b \_ bucket} + {P}_{{w}_{b}} \qquad ( 3 )$$

It should be noted that, T_{w_g} (R_{w_g},P_{w_g}) is the position and pose of the excavator's GPS positioning sensor in the global coordinate system; T_{g_b} (R_{g_b},P_{g_b}) is the position and pose of an excavator carrier coordinate system relative to a GPS positioning antenna; T_{b_i} (R_{b_i},P_{b_i}) is the position and pose of an IMU coordinate system relative to the GPS positioning antenna coordinate system; T_{i_l} (R_{i_l},P_{i_l}) is a position and pose of an lidar coordinate system relative to the IMU coordinate system; T_{b_bucket} (R_{b_bucket},P_{b_bucket}) is the position and pose of the bucket in the excavator carrier coordinate system.

Note that if a point cloud map of a working area is available for the excavator, a point cloud map of an area will be loaded, wherein the center of the area is P_{w_b} and the radius is the excavator's working radius.

If there is no point cloud map for the area, a point cloud map will be generated by the lidars.

The global map of the excavation and loading areas is loaded only once during the system initialization after the system is powered on.

In some embodiments, the center of the initial global point cloud map is the current position P_{w_b} of the excavator carrier of the engineering vehicle, and the radius of the initial global point cloud map is the working radius of the engineering vehicle.

In some embodiments, the current position P_{w_b} of the excavator carrier is determined according to the position P_{w_g} and the pose R_{w_g} of the positioning sensor of the excavator in the global coordinate system, and the position P_{g_b} of the excavator carrier coordinate system relative to a positioning antenna.

In some embodiments, as shown in formula (1), the current position P_{w_b} of the excavator carrier is the sum of the position P_{w_g} of the positioning sensor of the excavator in the global coordinate system and the product of the pose R_{w_g} of the positioning sensor of the excavator in the global coordinate system and the position P_{g_b} of the excavator carrier coordinate system relative to the positioning antenna.

In step 202, the global point cloud map is divided into areas to obtain a plurality of local point cloud maps.

It should be noted that when creating or updating a point cloud map by a lidar, registration between a current frame point cloud and a local map point cloud is performed to calculate a relative position and pose increment T_{l_incre} of the lidar to the local map, by iteratively multiplying the position and pose increment with the initial position and pose T_{w_l}, the position and pose of the lidar on the global map is updated. Based on the global position and pose of the lidar, the point cloud in lidar coordinates is transformed into the global map coordinate system, and then accumulated to obtain the global point cloud.

To improve the efficiency of point cloud registration, according to the feature that the excavator performs rotation operations most of the time, with the excavator carrier as the center, the global map of the excavation and loading areas is divided into eight areas 1-8 around 360 degrees as shown in FIG. 1. These areas are fixed and do not changed as the excavator rotates. Kdtrees are constructed for the point clouds of these eight areas, which are used as search trees for point cloud registration.

Note that the shape of the point cloud of each of these eight areas is not a sector, but is determined by the cumulative result of the actual shape of the point cloud scanned and registered in real time by the corresponding lidar within the area.

In step 203, an area where the each vehicular lidar of the plurality of the vehicle lidars is currently located is determined.

It should be noted that during the excavator's rotational excavation and loading construction, the local map area where each lidar is currently located is determined according to the real-time position and pose of the lidar. As shown in FIG. 1, the lidar 21 is located in the area 3, the lidar 22 is located in the area 4, the lidar 23 is located in the areas 5/6, the lidar 24 is located in the areas 7/8, and the lidar 25 is located in the areas 1/2. Corresponding critical areas can be further limited by a threshold of rotation angle.

In step 204, local point cloud maps corresponding to excavation and loading areas are updated at a first predetermined period by the plurality of the vehicle lidars.

FIG. 3 shows the steps of updating local point cloud maps corresponding to the excavation and loading areas according to some embodiments of the present application.

In step 301, local point cloud maps corresponding to the excavation and loading areas are generated at the first predetermined period.

According to the excavator's action status, as shown in FIG. 1, the excavator conducts an excavation operation in areas 1 and 8, and a loading operation in areas 3 and 4.

Due to the excavation or loading operation, the shape of the material changes, and the local maps of these areas will no longer be suitable. The real-time point clouds subsequently generated by the lidars cannot be registered with the initial local map point clouds. Therefore, it is necessary to directly clean the local map of the area where the bucket is located.

In some embodiments, the first predetermined period is 20 ms.

In step 302, an area where the bucket of the engineering vehicle is located is determined.

In some embodiments, the area where the bucket is located is determined according to a current position P_{w_bucket} of the bucket.

For example, the current position P_{w_bucket}, of the bucket is determined according to a current pose R_{w_b} and a current position P_{w_b} of the excavator carrier of the engineering vehicle, and a position P_{b_bucket} of the bucket in an excavator carrier coordinate system.

For example, as illustrated by formula (3), the current position P_{w_bucket} of the bucket is the sum of the current position P_{w_b} of the excavator carrier and the product of the current pose R_{w_b} of the excavator carrier and the position P_{b_bucket} of the bucket in the excavator carrier coordinate system.

In another embodiment, the local point cloud maps are divided into spatial grids, and the area where the bucket is located is determined according to the grid where the bucket is currently located.

In step 303, the local point cloud map of the area where the bucket is located is cleaned in a case where the engineering vehicle is carrying out an excavation and loading operation.

It should be noted that in a case where the engineering vehicle rotates without performing excavation or loading operations (the shape of the material does not change), the point cloud will not be cleaned according to the bucket position.

In step 304, a local point cloud map of the area where the bucket is located is regenerated.

A local point cloud map of the area corresponding to the bucket is regenerated according to the registration of the lidar point cloud.

Returning to FIG. 2, in step 205, local point cloud maps corresponding to non-excavation and loading areas are updated at a second predetermined period by the plurality of vehicle lidars.

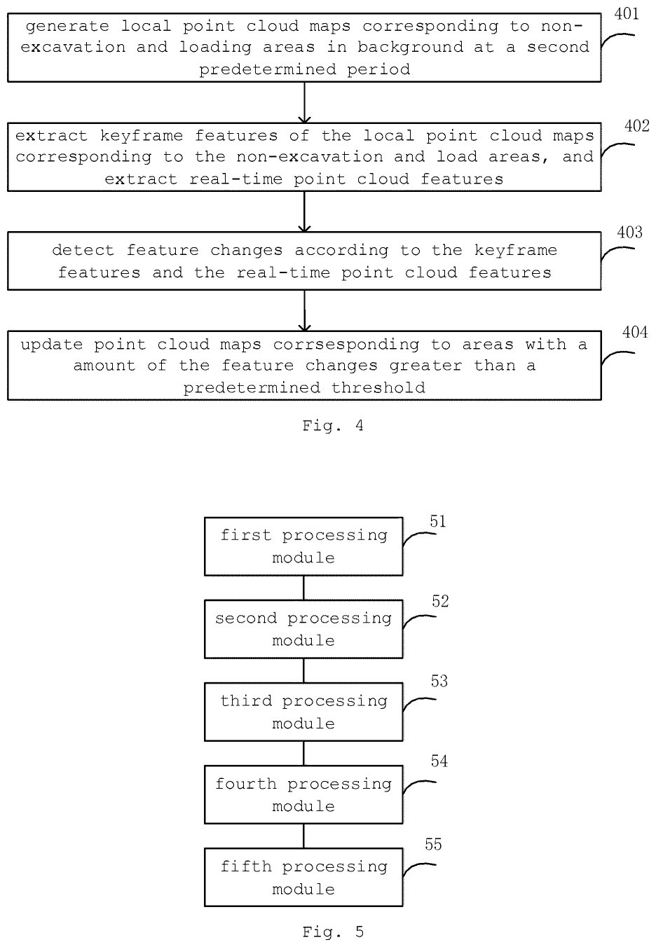

FIG. 4 shows the steps of the updating local point cloud maps corresponding to the non-excavation and loading areas according to some embodiments of the present application.

In step 401, the local point cloud maps corresponding to non-excavation and loading areas are updated in background at a second predetermined period.

It should be noted that for the non-excavation and loading area, the shape of the material generally does not change, except for situations such as sliding of the material, falling rocks in a truck parking area, or falling rocks in an excavator driving area, etc. To reduce the operating resources required by the system, a separate thread is created to update the local maps of the non-excavation and loading areas.

In some embodiments, the second predetermined period is 500 ms.

In some embodiments, the local map of the areas with shape changes are updated according to the keyframe feature matching.

In step 402, keyframe features of the local point cloud maps corresponding to the non-excavation and load areas are extracted, and real-time point cloud features are extracted.

In some embodiments, the steps of extracting the keyframe features of the local point cloud maps corresponding to the non-excavation and load areas comprises:
(1) the local point cloud maps corresponding to the non-excavation and load areas are divided into a plurality of cells of a predetermined size.

For example, the size of the each cell is 0.2 m.

Because the local point cloud maps contains all the cube cells, in order to quickly search for a cell, a hash table and an octree are constructed for the local point cloud maps, and cell searching is performed by using the octree.
(2) the features of the each cell are decomposed to determine whether the feature type of the each is a plane feature type.

For example, the features of the each cell is decomposed to obtain a first cell feature value λ₁, a second cell feature value λ₂ and a third cell feature value λ₃, wherein λ₁≥λ₂≥λ₃. If the second cell feature value λ₂ is much greater than the third cell feature value λ₃, it is determined that the feature type of the cell is the plane feature type.

In addition, if the first cell feature value λ₁ is much greater than the second cell feature value λ₂, it is determined that the feature type of the cell is a line feature type.
(3) the feature covariance of the plurality of the cells with the plane feature type is decomposed to obtain a rotation matrix.

In some embodiments, the feature covariance is decomposed to obtain three feature values λ_{d1}, λ_{d2}, λ_{d3}, and a corresponding feature vector V_{d}, wherein λ_{d1}≥λ_{d2}≥λ_{d3}, V_{d}=[V_{d1} V_{d2} V_{d3}].

Next, a rotation matrix R is obtained according to the feature vector V_{d}.

For example, the rotation matrix R=[V_{d1} V_{d2} V_{d1}×V_{d2}].
(4) directions of the features of the each cell are transformed according to the rotation matrix to obtain a rotationally invariant feature direction.
(5) keyframes of the each cell are extracted according to the feature direction.
(6) a feature histogram of an extracted keyframes is established.

It should be noted that a feature histogram is established for the extracted real-time point cloud features.

In step 403, feature changes are detected according to the keyframe features and the real-time point cloud features.

For example, it is determined whether the point cloud has changed according to the Euclidean distance between a keyframe feature and a real-time point cloud feature.

In step 404, point cloud maps corresponding to areas with an amount of the feature changes greater than a predetermined threshold are updated.

It should be noted that for areas with the amount of the feature changes not greater than the predetermined threshold, there is no need to update the point cloud maps.

Returning to FIG. 2, in step 206, the global point cloud map is updated according to the plurality of the updated local point cloud maps.

By dividing the global point cloud into spatial grids, filtering overlapping areas of the grids, and supplementing the point cloud for empty areas, an updated global map is created.

In the method for updating the point cloud map provided in the above embodiment of the present disclosure, the point cloud maps of the excavation and loading areas with scene changes are updated in a timely manner, thereby effectively meeting the requirements of excavation and loading scenarios.

FIG. 5 is a schematic structure diagram of apparatus for updating the point cloud map according to one embodiment of the present disclosure. As shown in FIG. 5, the apparatus for updating the point cloud map comprises a first processing module 51, a second processing module 52, a third processing module 53, a fourth processing module 54, and a fifth processing module 55.

The first processing module 51 is configured to load an initial global point cloud map corresponding to a current position of an engineering vehicle.

In some embodiments, the center of the initial global point cloud map is the current position P_{w_b} of the excavator carrier of the engineering vehicle, and the radius of the initial global point cloud map is the working radius of the engineering vehicle.

In some embodiments, the current position P_{w_b} of the excavator carrier is determined according to the position P_{w_g} and the pose R_{w_g} of the positioning sensor of the excavator in the global coordinate system, and the position P_{g_b} of the excavator carrier coordinate system relative to a positioning antenna.

In some embodiments, as shown in formula (1), the current position P_{w_b} of the excavator carrier is the sum of the position P_{w_g} of the positioning sensor of the excavator in the global coordinate system and the product of the pose R_{w_g} of the excavator positioning sensor in the global coordinate system and the position P_{g_b} of the excavator carrier coordinate system relative to the positioning antenna.

The second processing module 52 is configured to divide the global point cloud map into areas to obtain a plurality of local point cloud maps.

The third processing module 53 is configured to determine an area where each vehicular lidar of a plurality of vehicular lidars is currently located.

The fourth processing module 54 is configured to update local point cloud maps corresponding to excavation and loading areas at a first predetermined period, and update local point cloud maps corresponding to non-excavation and loading areas at a second predetermined period by the plurality of the vehicular lidars.

In some embodiments, the fourth processing module 54 is configured to perform the steps of any embodiments shown in FIG. 3 to update the local point cloud maps corresponding to excavation and loading areas at the first predetermined period. The fourth processing module 54 is further configured to perform the steps of any embodiments shown in FIG. 4 to update the local point cloud maps corresponding to the non-excavation and loading areas at the second predetermined period.

The fifth processing module 55 is configured to update the global point cloud map according to updating results of the plurality of the local point cloud maps.

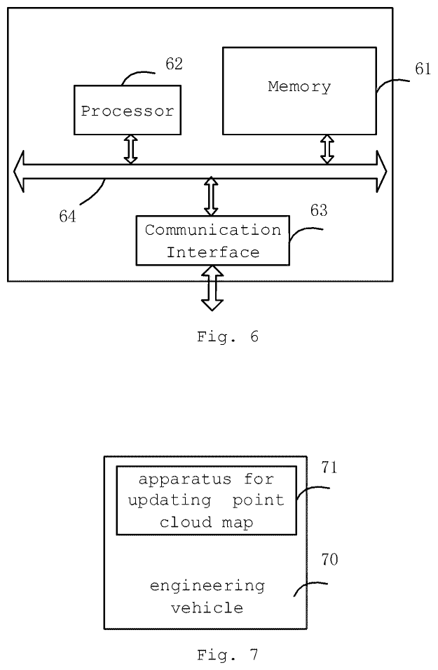

FIG. 6 is a schematic structure diagram of an apparatus for updating the point cloud map according to another embodiment of the present disclosure. As shown in FIG. 6, the apparatus for updating the point cloud map comprises a memory 61 and a processor 62.

The memory 61 is used to store instructions. The processor 62 is coupled to the memory 61, and is configured to, based on instructions stored in the memory, carry out a method involved in any one of the embodiments shown in FIGS. 2 and 4.

As shown in FIG. 6, the apparatus for updating the point cloud map further comprises a communication interface 63 for performing information interaction with other devices. In addition, the apparatus for updating the point cloud map further comprises a bus 64. The processor 62, the communication interface 63, and the memory 61 perform communication with each other through the bus 64.

The memory 61 may include a high speed RAM memory, and may also include a non-volatile memory such as at least one disk storage device. The memory 61 may also be a memory array. The memory 61 may also be partitioned into blocks, which may be combined into virtual volumes according to a certain rule.

In addition, the processor 62 may be a central processing unit (CPU), or may be an Application Specific Integrated Circuit (ASIC) or one or more integrated circuits configured to implement the embodiments of the present disclosure.

The present disclosure further discloses a computer-readable storage medium on which computer instructions are stored, which when executed by a processor implement the method according to any one of the embodiments shown in FIGS. 2 and 4.

FIG. 7 is a schematic structure diagram of an engineering vehicle according to one embodiment of the present disclosure. As shown in FIG. 7, the engineering vehicle 70 comprises a the apparatus for updating the point cloud map 71, the apparatus for updating the point cloud map 71 is the apparatus for updating the point cloud map according to any one of the embodiments of FIGS. 5 and 6.

In some embodiments, the engineering vehicle 70 comprises an excavator.

In the above embodiments of the present disclosure, the following beneficial effects can be achieved.
(1) in a case where the excavator returns to the platform after servicing, or in a case where the work area of the excavator is changed, a point cloud map created previously can be automatically loaded.
(2) in a case where that the shape of the material in the excavation or loading area changes as the bucket performs an excavation operation in an excavation area or a loading operation on a truck, the perception system can dynamically update the point cloud map of the excavation and loading areas in real time;
(3) in a case where the map of the non-excavation and loading areas changes due to a landslide of the material or other equipment entering the site for crushing and cleaning operations, the perception system can update the map in background.
(4) in a case where the multiple lidars are enabled, the perception system can perform real-time map updates by using the multiple lidars simultaneously.
(5) in a case where the excavator continuously rotates to perform repeatedly excavation and loading operations, the 3D environment is continuously mapped by the lidars of the perception system, resulting in continuous accumulation of the point cloud, but the size of the point cloud map can be reasonably limited and the uniformity of the map can be ensured.

In some embodiments, the above functional modules can be implemented as a general-purpose processor for performing the functions described in this disclosure, Programmable logic controller (PLC), digital signal processor (DSP), application specific integrated circuit (ASIC), field programmable gate array (FPGA) or other programmable logic devices, discrete gates or transistor logic devices, discrete hardware components or any appropriate combination thereof.

A person skilled in the art can understand that all or part of the steps for carrying out the method in the above embodiments can be completed by hardware or a program instructing the related hardware, wherein the program can be stored in a computer readable storage medium. The storage medium may be a read-only memory (ROM), a magnetic disk or a compact disk (CD).

The above description of this invention is given for illustration and description, but is not exhaustive and is not intended to limit the present invention to the form disclosed herein. Various modifications and variations are apparent for a person of ordinary skill in the art. Embodiments are selected and described for a better illustration of the principle and practical application of this invention, so that those skilled in the art can understand this invention and envisage various embodiments with various modifications suited to specific usages.

1. A method for updating a point cloud map, comprising:
loading an initial global point cloud map corresponding to a current position of an engineering vehicle;
dividing the global point cloud map into areas to obtain a plurality of local point cloud maps;
determining an area where each vehicular lidar of a plurality of vehicular lidars is currently located;
updating local point cloud maps corresponding to excavation and loading areas at a first predetermined period, and updating local point cloud maps corresponding to non-excavation and loading areas at a second predetermined period by the plurality of the vehicular lidars; and
updating the global point cloud map according to updating results of the plurality of the local point cloud maps.

2. The method for updating the point cloud map according to claim 1, wherein the updating the local point cloud maps corresponding to the excavation and loading areas at the first predetermined period comprises:
generating the local point cloud maps corresponding to the excavation and loading areas at the first predetermined period;
determining an area where a bucket of the engineering vehicle is located;
cleaning a local point cloud map of the area where the bucket is located in a case where the engineering vehicle is carrying out an excavation and loading operation; and
regenerating the local point cloud map corresponding to the area where the bucket is located.

3. The method for updating the point cloud may according to claim 2, wherein the determining the area where the bucket of the engineering vehicle is located comprises:
determining the area where the bucket is located according to a current position P_{w_bucket} of the bucket.

4. The method for updating the point cloud map according to claim 3, wherein
the current position P_{w_bucket} of the bucket is determined according to a current pose R_{w_b} and a current position P_{w_b} of an excavator carrier of the engineering vehicle, and a position P_{b_bucket} of the bucket in an excavator carrier coordinate system.

5. The method for updating the point cloud map according to claim 4, wherein
the current position P_{w_bucket} of the bucket is a sum of the current position P_{w_b} of the excavator carrier and a product of the current pose R_{w_b} of the excavator carrier and the position P_{b_bucket} of the bucket in the excavator carrier coordinate system.

6. The method for updating the point cloud map according to claim 2, wherein the determining the area where the bucket of the engineering vehicle is located comprises:
dividing the local point cloud maps corresponding to the excavation and loading areas into spatial grids; and
determining the area where the bucket is located according to a grid where the bucket is currently located.

7. The method for updating the point cloud may according to claim 1, wherein the updating local point cloud maps corresponding to the non-excavation and loading areas at the second predetermined period comprises:
updating the local point cloud maps corresponding to the non-excavation and loading areas in background at the second predetermined period;
extracting keyframe features of the local point cloud maps corresponding to the non-excavation and loading areas, and extracting real-time point cloud features;
detecting feature changes according to the keyframe features and the real-time point cloud features; and
updating point cloud maps corresponding to areas with an amount of the feature changes greater than a predetermined threshold.

8. The method for updating the point cloud map according to claim 7, wherein the extracting the keyframe features of the local point cloud maps corresponding to the non-excavation and loading areas comprises:
dividing the local point cloud maps corresponding to the non-excavation and loading areas into a plurality of cells with a predetermined size;
decomposing features of each cell of the plurality of the cells to determine whether a feature type of the each cell is a plane feature type;
decomposing a feature covariance of a plurality of cells with the plane feature type to obtain a rotation matrix;
transforming directions of the features of the each cell according to the rotation matrix to obtain a rotationally invariant feature direction;
extracting keyframes of the each cell according to the feature direction; and
establishing a feature histogram of the extracted keyframes.

9. The method for updating the point cloud map according to claim 8, wherein the decomposing features of the each cell of the plurality of the cells to determine whether the feature type of the each cell is the plane feature type comprises:
decomposing features of the each cell to obtain a first cell feature value λ₁, a second cell feature value λ₂, and a third cell feature value λ₃, wherein λ₁≥λ₂≥λ₃; and
determining the each cell has a plane feature type in a case where the second cell feature value λ₂ is much greater than the third cell feature value λ₃.

10. The method for updating the point cloud map according to claim 8, wherein the decomposing the feature covariance of the plurality of the cells with the plane feature type to obtain the rotation matrix comprises:
decomposing the feature covariance to obtain a feature vector V_{d}; and
obtaining the rotation matrix R according to the feature vector V_{d}.

11. The method for updating the point cloud map according to claim 10, wherein:
$$the feature vector {V}_{d} = [ {V}_{d 1} {V}_{d 2} {V}_{d 3} ] ; and$$
$$the rotation matrix R = [ {V}_{d 1} {V}_{d 2} {V}_{d 1} \times {V}_{d 2} ] .$$

12. The method for updating the point cloud map according to claim 1 wherein
a center of the initial global point cloud map is a current position P_{w_b} of the excavator carrier of the engineering vehicle, and a radius of the initial global point cloud map is a working radius of the engineering vehicle.

13. The method for updating the point cloud map according to claim 12, wherein
the current position P_{w_b} of the excavator carrier is determined according to a position P_{w_g} and a pose R_{w_g} of an positioning sensor of the excavator in the global coordinate system, and a position P_{g_b} of the excavator carrier coordinate system relative to a positioning antenna.

14. The method for updating the point cloud may according to claim 13, wherein
the current position P_{w_b} of the excavator carrier is a sum of the position P_{w_g} of the excavator positioning sensor in the global coordinate system and the product of the pose R_{w_g} of the excavator positioning sensor in the global coordinate system and the position P_{g_b} of the excavator carrier coordinate system relative to the positioning antenna.

15. (canceled)

16. A apparatus for updating a point cloud map, comprising:
a processor; and
a memory coupled to the processor, storing program instructions which, when executed by the processor, cause the processor to implement a method for updating the point cloud map comprising:
loading an initial global point cloud map corresponding to a current position of an engineering vehicle;
dividing the global point cloud map into areas to obtain a plurality of local point cloud maps;
determining an area where each vehicular lidar of a plurality of vehicular lidars is currently located;
updating local point cloud maps corresponding to excavation and loading areas at a first predetermined period, and updating local point cloud maps corresponding to non-excavation and loading areas at a second predetermined period by the plurality of the vehicular lidars; and
updating the global point cloud map according to updating results of the plurality of the local point cloud maps.

17. An engineering vehicle, comprising:
the apparatus for updating the point cloud map of claim 16.

18. The engineering vehicle according to claim 17, wherein the engineering vehicle comprises an excavator.

19. A non-transitory computer readable storage medium stored thereon computer instructions that, when executed by a processor, implement a method for updating a point cloud map comprising:
loading an initial global point cloud map corresponding to a current position of an engineering vehicle;
dividing the global point cloud map into areas to obtain a plurality of local point cloud maps;
determining an area where each vehicular lidar of a plurality of vehicular lidars is currently located;
updating local point cloud maps corresponding to excavation and loading areas at a first predetermined period, and updating local point cloud maps corresponding to non-excavation and loading areas at a second predetermined period by the plurality of the vehicular lidars; and
updating the global point cloud map according to updating results of the plurality of the local point cloud maps.

20. (canceled)

21. The apparatus for updating a point cloud map according to claim 16, wherein the updating the local point cloud maps corresponding to the excavation and loading areas at the first predetermined period comprises:
generating the local point cloud maps corresponding to the excavation and loading areas at the first predetermined period;
determining an area where a bucket of the engineering vehicle is located;
cleaning a local point cloud map of the area where the bucket is located in a case where the engineering vehicle is carrying out an excavation and loading operation; and
regenerating the local point cloud map corresponding to the area where the bucket is located.

22. The apparatus for updating a point cloud map according to claim 16, wherein the updating local point cloud maps corresponding to the non-excavation and loading areas at the second predetermined period comprises:
updating the local point cloud maps corresponding to the non-excavation and loading areas in background at the second predetermined period;
extracting keyframe features of the local point cloud maps corresponding to the non-excavation and loading areas, and extracting real-time point cloud features;
detecting feature changes according to the keyframe features and the real-time point cloud features; and
updating point cloud maps corresponding to areas with an amount of the feature changes greater than a predetermined threshold.
